(19) United States
(12) Patent Application Publication
(10) Pub. No.: US 2014/0347156 A1
(43) Pub. Date: Nov. 27, 2014

(54) COIL, REACTOR, AND COIL FORMATION METHOD

(71) Applicant: NEC TOKIN CORPORATION, Sendai-shi, Miyagi (JP)

(72) Inventor: Kazuyuki Ono, Sendai-shi (JP)

(73) Assignee: NEC TOKIN CORPORATION

(21) Appl. No.: 14/363,754

(22) PCT Filed: Oct. 24, 2012
(86) PCT No.: PCT/JP2012/077411

§ 371 Date: Jun. 6, 2014

(30) Foreign Application Priority Data
Dec. 7, 2011 (JP) 2011-267929

(51) Int. Cl. H01F 27/00; H01F 27/29; H01F 41/06; H01F 27/28

(52) U.S. Cl. CPC H01F 27/006; H01F 27/2847; H01F 27/29; H01F 41/06; H01F 2027/2857
USPC 336/192; 336/207; 29/605

(57) ABSTRACT

An inner margin adjoining an inner lead is used as the innermost part of a conductive member made of a film conductor. The inner margin is held by a bobbin upon a winding a coil. Therefore, mutual displacement, or the like, between the film conductor, or the conductive member, and an insulation separator upon the coil-winding can be prevented.

### TECHNICAL FIELD

This invention relates to a coil made of a film conductor and relates to a reactor comprising the coil and used in a power supply circuit.

### BACKGROUND ART

Patent Document 1 discloses a formation method of a lead portion (lead wire) of a coil made of a film conductor. The lead portion of the Patent Document 1 is formed only by folding without slitting the film conductor.

### PRIOR ART DOCUMENTS

### Patent Document(s)

Patent Document 1: JPU H06-86312

### SUMMARY OF INVENTION

### Technical Problem

When a coil is actually formed, a film conductor is wound together with an insulation separator. When a coil is formed based on a disclosure in the Patent Document 1, mutual displacement between the insulation separator and the film conductor, in particular, at their winding start positions can occur.

It is therefore an object of the present invention to provide a coil, which is formed to prevent mutual displacement between an insulation separator and a film conductor at their winding start positions, and a reactor using the coil.

### Solution to Problem

An aspect of the present invention provides a coil formed by winding a conductive member and an insulation separator together, wherein:

the conductive member is formed by folding a film conductor and includes two ends of an inner end and an outer end and a coil main positioned between the inner end and the outer end;

the inner end is positioned on a center of the coil while the outer end is positioned at the outermost portion of the coil;

the inner end includes an inner lead and an inner margin, the inner margin being positioned between the inner lead and the coil main, the inner margin being doubled over to have a predetermined size in a circumference direction, the inner margin forming the innermost portion of the conductive member in the circumference direction;

the outer end includes an outer lead; and

the inner lead and the outer lead project out beyond the coil main in a winding-axis direction intersecting the circumference direction.

Another aspect of the present invention provides a coil formation method comprising:

a forming step in which an inner lead and an inner margin are formed by folding an one end of a film conductor and its vicinity in a longitudinal direction, the inner lead projecting out beyond an edge of the film conductor in the lateral direction of the film conductor, the inner margin being positioned between a main section of the film conductor and the inner lead, the inner margin being a centralmost portion in the coil by being doubled over to have a predetermined size in the longitudinal direction, the main section becoming the coil main by being wound in a later step; and

a winding step in which the film conductor and an insulation separator are wound together in a state where the inner margin is held by a bobbin.

Yet another aspect of the present invention provides a reactor formation method, wherein:

the reactor comprises the coil, an inner terminal, an outer terminal, an inner aluminum pin, an outer aluminum pin, the coil being formed by winding the conductive member made of aluminum foil and the insulation separator together, the coil having the inner lead and the outer lead, the inner lead pulled out from an one end of the conductive member, the outer lead pulled out from the other end of the conductive member, the inner lead and the outer lead are electrically connected with the inner terminal and the outer terminal by the inner aluminum pin and the outer aluminum pin, respectively; and

the inner lead and the outer lead are welded to the inner aluminum pin and the outer aluminum pin, respectively, through ultra-sonic welding by using a pressing member including a pressing portion, the pressing portion having a shape based on an assembly consisting of a plurality of cones or pyramids, the pressing portion having an outer peripheral shape which neither include a corner part of a right angle nor a corner part of an acute angle.

Still another aspect of the present invention provides the aforementioned reactor formation method, wherein:

the pressing portion has an outer peripheral shape obtained by chamfering or rounding corner parts of a quadrangle; and

a pressing mark is provided by the pressing member having the pressing portion.

### Advantageous Effects of Invention

According to the present invention, the inner margin adjacent to the inner lead is formed as the innermost part of the conductive member made of the film conductor. The inner margin is held by or fixed to the bobbin or the like upon a winding the coil. Therefore, mutual displacement, or the like, between the film conductor (conductive member) and the insulation separator upon the coil-winding can be prevented.

An appreciation of the objectives of the present invention and a more complete understanding of its structure may be had by studying the following description of the preferred embodiment and by referring to the accompanying drawings.

### BRIEF DESCRIPTION OF DRAWINGS

FIG. 1 is a perspective view schematically showing a connector according to an embodiment of the present invention.

FIG. 2 is a perspective view showing a coil used in a reactor of FIG. 1.

FIG. 3 is a view showing a conductive member as a material of the coil of FIG. 2.

FIG. 4 is a view showing a process for formation of the coil of FIG. 2.

FIG. 5 is a view showing a process following the process showed in FIG. 4.

FIG. 6 is a view showing a process following the process showed in FIG. 5.

FIG. 7 is a view showing a process following the process showed in FIG. 6.

FIG. 8 is a view showing a process following the process showed in FIG. 7.

FIG. 9 is a view showing a process following the process showed in FIG. 8.

FIG. 10 is a view showing a film conductor (conductive member) obtained as a result of the process showed in FIG. 9.

FIG. 11 is a view showing a state where the film conductor (conductive member) of FIG. 10 is slightly opened.

FIG. 12 is a view showing a relationship the film conductor (conductive member) of FIG. 10 and an insulation separator.

FIG. 13 is a view showing a process for formation of the coil of FIG. 2 with the file conductor of FIG. 10 and the insulation separator.

FIG. 14 is a view showing a process following the process showed in FIG. 13.

FIG. 15 is a view showing a process following the process showed in FIG. 14.

FIG. 16 is a view showing a process following the process showed in FIG. 15.

FIG. 17 is a view showing a process following the process showed in FIG. 16.

FIG. 18 is a view showing a state where a terminal is attached to an inner lead or an outer lead of the coil of FIG. 1 when seen along a winding-axis direction; the other parts of the coil are omitted from the illustration.

FIG. 19 is a cross-sectional view showing the terminal of FIG. 18 and the vicinity thereof, take along line XIX-XIX.

FIG. 20 is a view showing a modification of the terminal of FIG. 18 and the vicinity thereof.

FIG. 21 is a view showing another modification of the terminal of FIG. 18 and the vicinity thereof.

FIG. 22 is a view showing yet another modification of the terminal of FIG. 18 and the vicinity thereof.

FIG. 23 is a cross-sectional view showing the terminal of FIG. 22 and the vicinity thereof, take along line XXIII-XXIII.

FIG. 24 is a front view showing the terminal of FIG. 22 and the vicinity thereof.

FIG. 25 is a view showing a pressing member used in ultra-sonic welding.

FIG. 26 is a front view showing the pressing member of FIG. 25.

FIG. 27 is a view showing a modification of the conductive member of FIG. 3.

FIG. 28 is a view showing a modification of an inner lead of FIG. 3. The illustrated inner lead according to the modification is formed in a folding way different from the inner lead of FIG. 3.

FIG. 29 is a view showing a formation method of the inner lead of the modification shown in FIG. 28.

FIG. 30 is a view showing a modification of the insulation separator.

FIG. 31 is a view showing another modification of the insulation separator.

FIG. 32 is a view showing yet another modification of the insulation separator.

### DESCRIPTION OF EMBODIMENTS

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

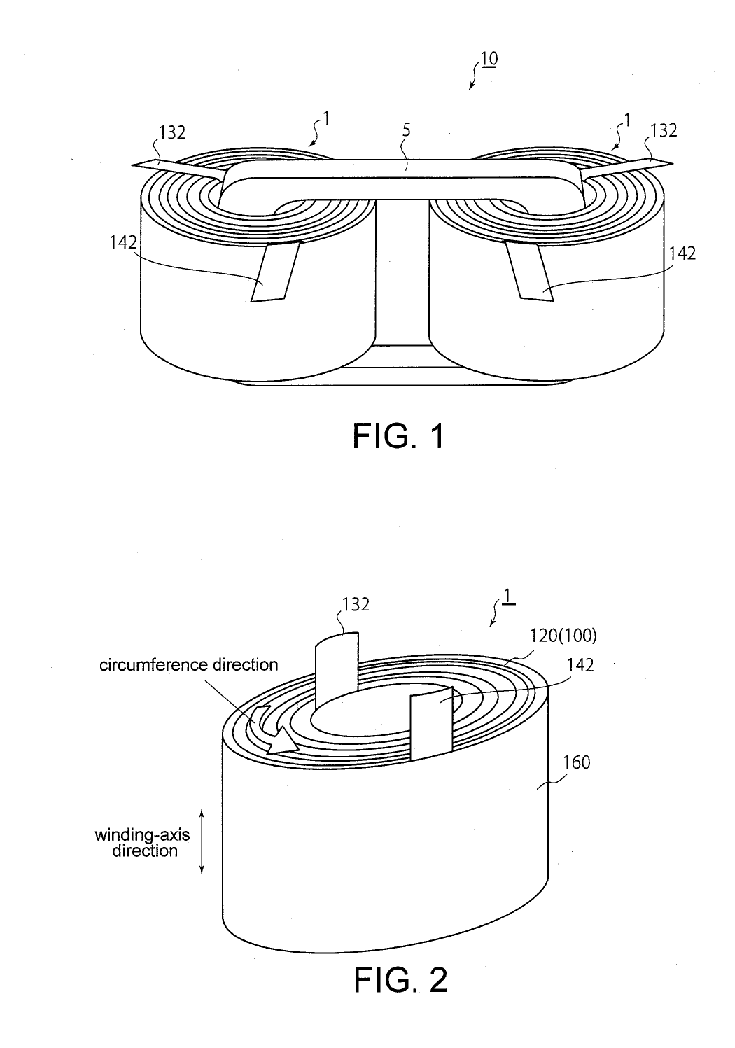

As shown in FIG. 1, a reactor 10 according to the present embodiment comprises two coils 1 and a magnetic core 5. The reactor 10 according to the present embodiment is applicable to a coil component combined with a medium-to-small-sized magnetic core and used for (energy-saving) an electric power converter and a low-pass filter. In detail, the reactor 10 according to the present embodiment is usable as an energy-storage reactor in a boost-up high voltage converter high frequency switching. The reactor 10 according to the present embodiment is usable as an AC reactor (ACL) and a DC reactor (DCL) which are included in a high current converter and a harmonic wave filter (low pass filter) of an inverter. The reactor 10 according to the present embodiment is usable as a large current transformer or as a zero-phase device for countermeasure against radiation conduction noise. The reactor 10 according to the present embodiment is usable as an electromagnetic induction coil at heat load side in an electromagnetic cooking device or the like. Furthermore, the reactor 10 according to the present embodiment is usable as an electromagnetic induction coil for contactless charging to carry out electric power transmission in depth of space on wide range. Upon an actual use, the reactor 10 in a state shown in FIG. 1 may be attached with a terminal (as described later), and the reactor 10 as a whole may be accommodated in a case.

As shown in FIG. 2, a coil 1 according to the present embodiment is a so-called coil of a foil, and the coil 1 has an inner lead 132 and an outer lead 142 which project out in the winding-axis direction of the coil 1. Hereinafter, a structure of the coil and a formation method thereof will be mainly explained.

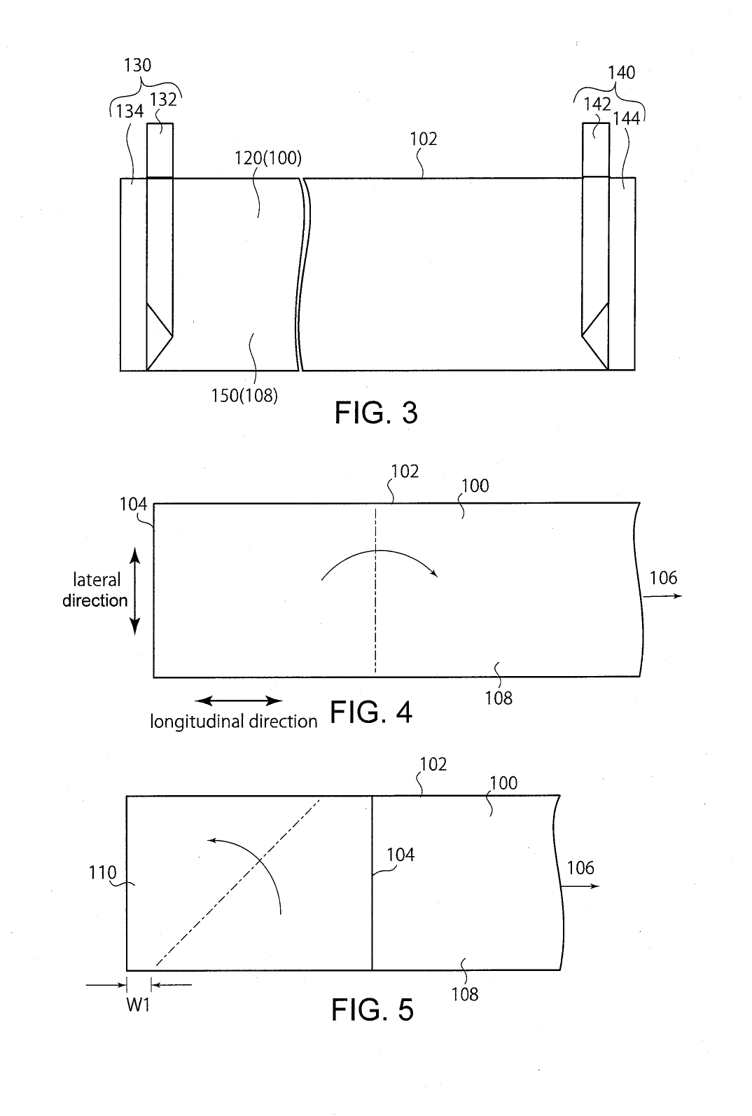

Referring to FIGS. 2 to 4, the coil 1 is formed by winding a conductive member 120 (see FIG. 3) and an insulation separator 160 together (see FIG. 2), wherein the conductive member 120 is formed by folding a film conductor 100 (see FIG. 4). The film conductor 100 according to the present embodiment is made of aluminum foil. In addition, as understood from FIGS. 2 to 4, the winding-axis direction of the coil 1 is the lateral direction of the film conductor 100, and the circumference direction of the coil 1 is the longitudinal direction of the wound film conductor 100.

As shown in FIG. 3, the conductive member 120 includes two ends of an inner end 130 and an outer end 140, and a coil main 150 positioned between the inner end 130 and the outer end 140. The inner end 130 is a part positioned at a center side of the coil 1, and the outer end 140 is an end positioned at the outermost portion of the coil 1. In an actual formation process of the coil 1, instead of winding the conductive member 120 after forming the conductive member 120 as shown in FIG. 3, as described later, the outer end 140 is formed after winding the conductive member 120 (film conductor 100) as described later. However the structures of the coils 1 are not different from each other. For the sake of easy understanding, structure and positional relation in each part of the conductive member 120 is herein be explained with FIG. 3.

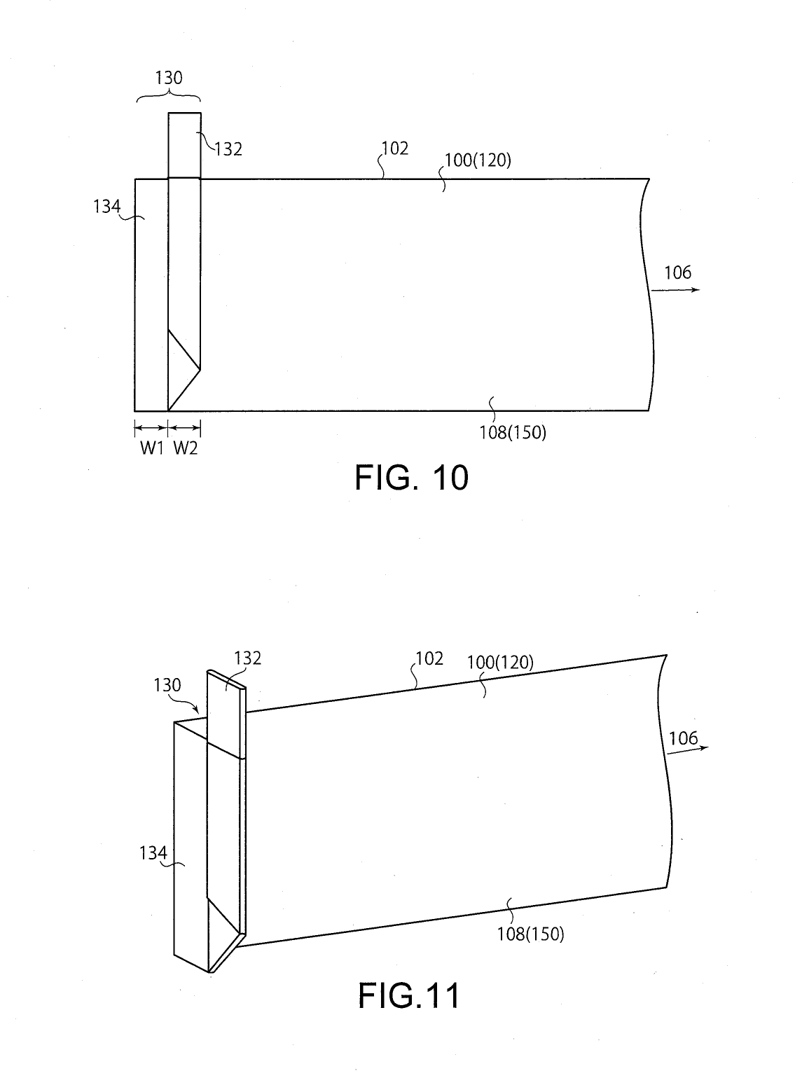

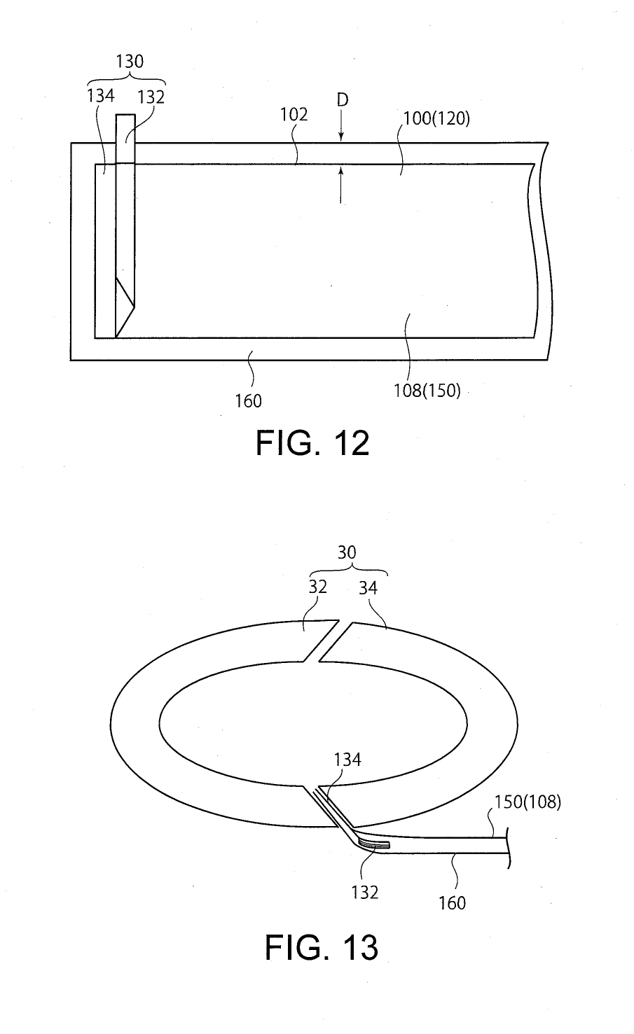

As shown in FIG. 3, the inner end 130 includes the inner lead 132 and an inner margin 134. The inner lead 132 projects out beyond an edge 102 of the film conductor 100 in the lateral direction of the film conductor 100. Specifically, the inner lead 132 projects out beyond the coil main 150 in the winding-axis direction of the coil 1. Referring to FIGS. 10 and 11 in addition to FIG. 3, the inner margin 134 is positioned between the inner lead 132 and the coil main 150. The inner margin 134 is doubled over to have a predetermined size W1 in the longitudinal direction of the film conductor 100 (i.e. circumference direction of the coil 1) and forms an end of the conductive member 120 in the longitudinal direction of the film conductor 100. In other words, under a state where the conductive member 120 is wound, the inner margin 134 forms the innermost portion of the conductive member 120 in the circumference direction of the coil 1. In addition, as can be seen from FIG. 3, the inner margin 134 does not project out beyond the edge 102 of the film conductor 100 in the lateral direction of the film conductor 100. In other words, the inner margin 134 does not project out beyond the coil main 150 in the winding-axis direction of the coil 1.

As shown in FIG. 3, the outer end 140 according to the present embodiment includes the outer lead 142 and an outer margin 144. As with the inner lead 132, the outer lead 142 projects out beyond the coil main 150 in the winding-axis direction of the coil 1. As with the inner margin 134, the outer margin 144 is positioned between the outer lead 142 and the coil main 150. The outer margin 144 is doubled over in the longitudinal direction of the film conductor 100 and forms an end of the conductive member 120. In other words, under a state where the conductive member 120 is wound, the outer margin 144 forms the outermost portion of the conductive member 120 in the circumference direction of the coil 1. In addition, as can be seen from FIG. 3, the outer margin 144 does not project out beyond the edge 102 of the film conductor 100 in the lateral direction of the film conductor 100. In other words, the outer margin 144 does not project out beyond the coil main 150 in the winding-axis direction of the coil 1.

Hereinafter, a formation method of the inner end 130 is explained by using FIGS. 4 to 11. Then, a formation method of the coil 1, by using the film conductor 100 (conductive member 120) including the inner end 130, is explained.

An one end 104 in the longitudinal direction, of the film conductor 100 shown in FIG. 4 is doubled over toward the other end 106 in the longitudinal direction, of the film conductor 100 shown in FIG. 5.

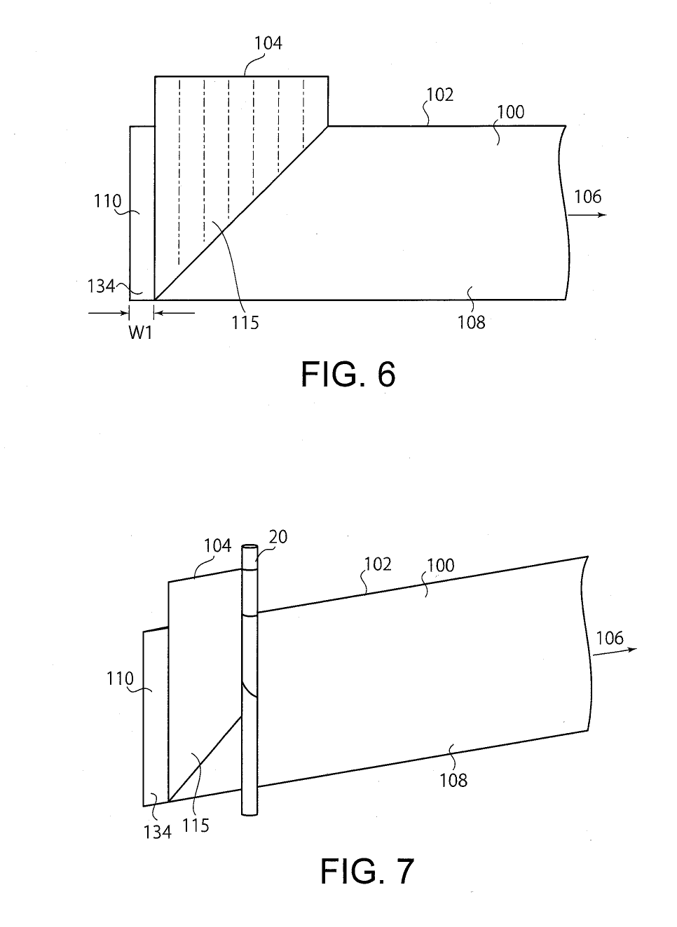

Then, as shown in FIG. 6, the one end 104 is folded with a double-over portion 110 of a predetermined size W1 left and with the one end 104 projecting out beyond the edge 102 of the film conductor 100 in the lateral direction, so that the inner margin 134 having the predetermined size W1 and an folded portion 115 are formed. As understood from the above, the folded portion 115 includes an overlapped portion where a part of the film conductor 100 is doubled over in triangular form. In detail, the folded portion 115 according to the present embodiment includes the overlapped portion having an isosceles right triangular shape.

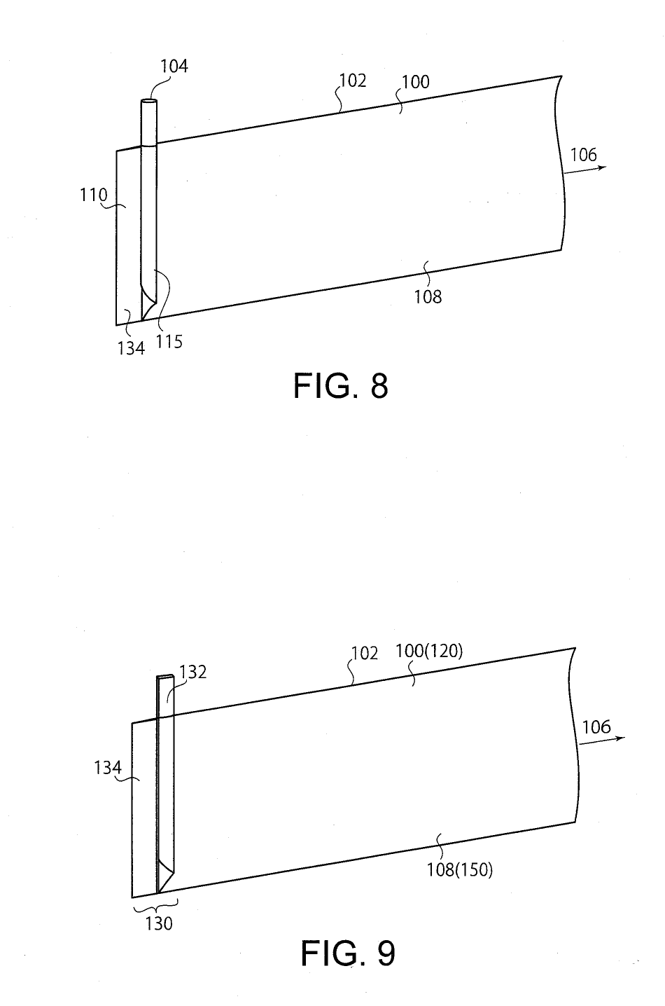

Then, the inner lead 132 is formed by folding the folded portion 115. More specially, after the folded portion 115 is wound around a winding core 20 having a predetermined diameter as shown in FIG. 7, the winding core 20 is removed as shown in FIG. 8 while the wound folded portion 115 is pressed. Thus, as shown in FIG. 9, the inner lead 132 is formed to project out beyond the edge 102 of the film conductor 100 in the lateral direction of the film conductor 100.

In consideration of easy handling due to softness of electroconductive foil in a manufacturing process and improvement of its electrical conductivity, it is preferable that an annealed material of a pure aluminum foil having a purity of 99.3 to 99.99% is used as the film conductor 100. It is preferable that the number of layers of the inner lead 132 (how many times parts of the film conductor 100 are overlapped) is, considering a winding process described later, 5 to 7 if a thickness of the film is under about 150 μm. If the film has a thickness of from 150 μm and to about 300 μm, it is preferable that the number of layers of the inner lead 132 is 4 or less. It is preferable that the predetermined size W1 of the inner margin 134 is 0.1 to 15 times a size W2 of the inner lead 132 in the circumference direction. Specifically, it is preferable that the predetermined size W1 is 0.5 to 5 times the size W2 so as to obtain effect of preventing mutual displacement in the winding process described later.

Thus, after the inner end 130 is formed as shown in FIGS. 10 and 11, the film conductor 100 and the insulation separator 160 are wound together. To avoid a short circuit or the like between the layers of the wound film conductor 100, it is necessary to protect and to insulate the edge 102 of the film conductor 100. Therefore, it is preferable that a difference D between the edge 102 and another edge of the insulation separator 160 is 50 μm to 10 mm. It is more preferable that the difference D is 2 mm to 3 mm. In addition, to protect the edge 102, the insulation separator 160 may be folded to cover the edge 102. In this case, in a state before folding the insulation separator 160, it is preferable that the difference D is 2 mm to 10 mm. It is more preferable that the difference D is 2 mm to 3 mm. In addition, it is preferable that an insulation film used as the insulation separator 160 has a thickness of 40 μm to 80 μm. This is because it is difficult to secure insulation performance of the edge 102 if the thickness is under 40 μm while it is difficult to ensure miniaturization of the coil 1 if the thickness is over 80 μm.

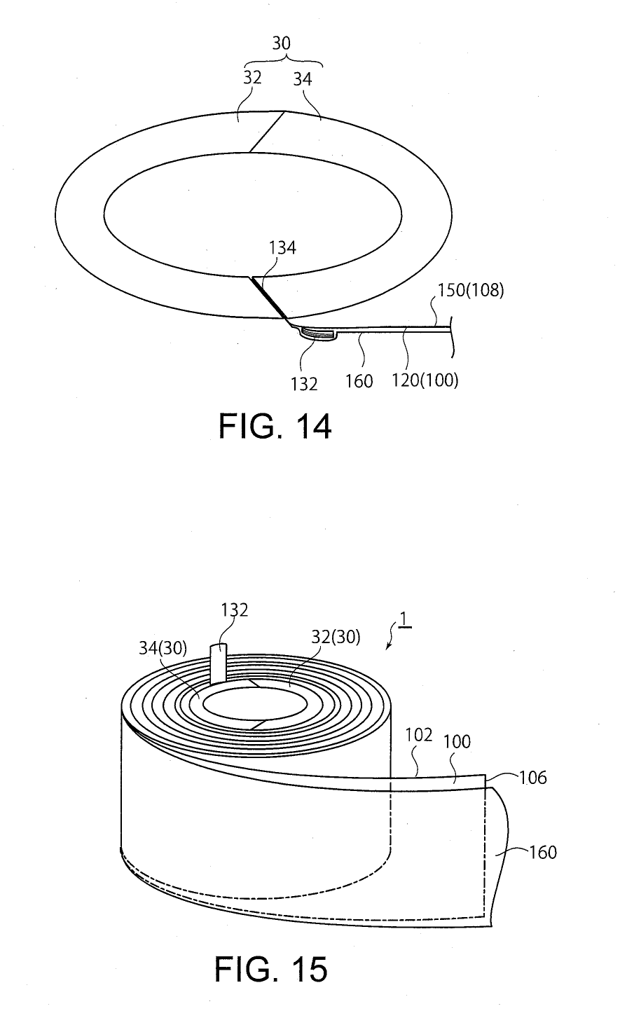

In the winding process according to the present embodiment, a bobbin 30 consisting of two split bobbins 32, 34 is used as shown in FIG. 13. In detail, as understood from FIGS. 13 and 14, the inner margin 134 and an end of the insulation separator 160 are put between the two split bobbins 32, 34 to be held therebetweeen. Meanwhile, the inner lead 132 do not directly contact the bobbin 30. A main section 108, which becomes the coil main 150, of the film conductor 100 is interposed between the inner lead 132 and the bobbin 30. With such a configuration, a possibility that the thickness of the inner lead 132 causes a problem upon the coil-winding can be reduced. However, the present invention is not limited thereto. For example, the inner lead 132 may be positioned inside of the bobbin 30 to be directly brought into contact with the bobbin 30. The bobbin 30 may hold the inner margin 134 under a state where the inner margin 134 is doubled over the insulation separator 160 in the longitudinal direction thereof to be put between parts of the insulation separator 160. Namely, at a part held by the bobbin 30, the insulation separator 160, the inner margin 134 and the insulation separator 160 are sequentially stacked. Furthermore, in this case, the insulation separator 160, which is doubled over, may be positioned at an inside of the inner lead 132.

Then, as shown in FIG. 15, the film conductor 100 is wound on the bobbin 30 together with the insulation separator 160. At that time, as described above, because the inner margin 134 and the end of the insulation separator 160 are sandwiched between the two split bobbins 32, 34 to be held therebetween in the present embodiment, mutual displacement between the film conductor 100 (conductive member 120) and the insulation separator 160 upon the coil-winding can be prevented. In addition, even if the two split bobbins 32, 34 sandwich only the inner margin 134 therebetween without sandwiching the end of the insulation separator 160 therebetween, effect of preventing mutual displacement of the conductive member 120 made of the film conductor 100 can be obtained. However, to prevent mutual displacement effectively, it is preferable that the film conductor 100 is wound together with the insulation separator 160 while the two split bobbins 32, 34 sandwich and hold the inner margin 134 and the end of the insulation separator 160 therebetween as described above.

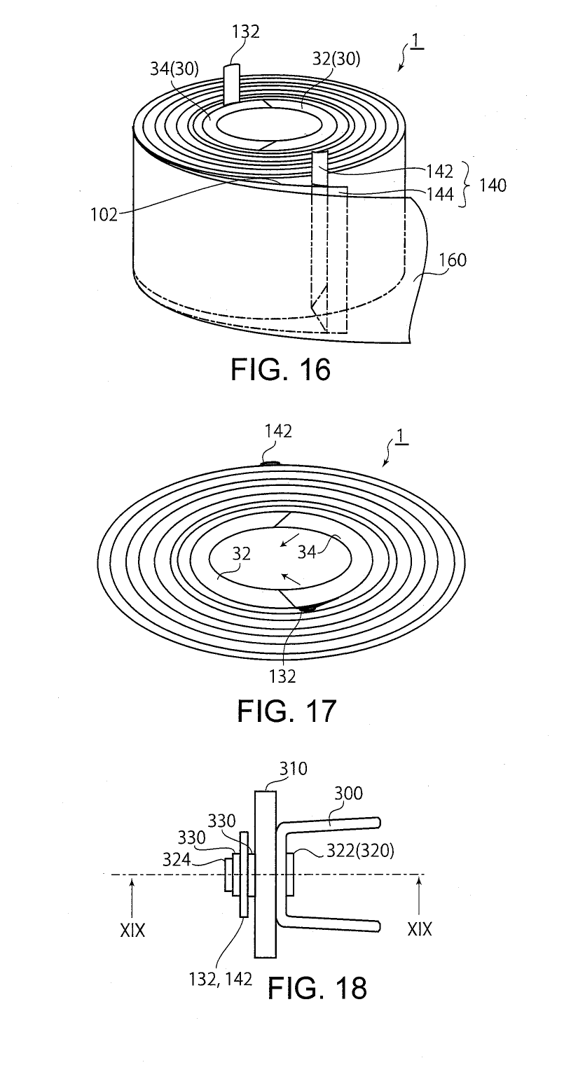

Then, as shown in FIG. 16, the outer end 140 is formed. A formation method of the outer end 140 is same as the formation method of the inner end 130. In detail, as understood from FIGS. 15 and 16, after the other end 106 of the film conductor 100 is folded toward the one end 104, the other end 106 is folded to project out beyond the edge 102 of the film conductor 100 in the lateral direction (winding-axis direction) while the double-over portion is partly left, so that the outer folded portion is formed while the outer margin 144 is formed to be the outer most end of the coil 1. Furthermore, the outer lead 142 is formed by folding the outer folded portion.

Then, the insulation separator 160 is further wound by about two turns so that the coil 1 as shown in FIG. 17 is obtained. At that time, since the outermost end of conductive member 120 is not the outer lead 142 but the outer margin 144, the outer margin 144 and the coil main 150 positioned at opposite ends of the outer lead 142 are pressed toward an inner circumference side, the position of the outer lead 142 interposed by the outer margin 144 and the coil main 150 is stabilized.

Thereafter, the split bobbin 34 is swaged to be pushed inward of the split bobbin 32, so that the split bobbin 32 and the split bobbin 34 are separated. Then, the split bobbin 32 and the split bobbin 34 are removed so that an air-core coil (coil 1) as shown in FIG. 2 is obtained.

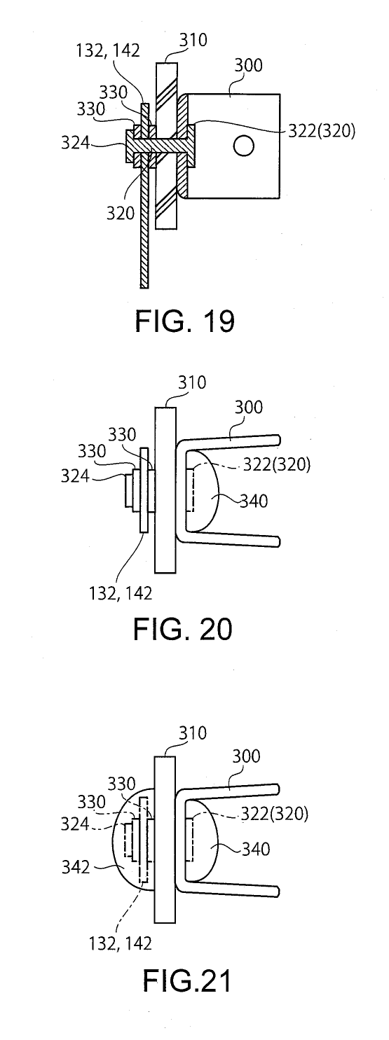

On the inner lead 132 and the outer lead 142 of the thus-obtained coil 1, a terminal (inner terminal or outer terminal) 300 made of conductors other than aluminum is attached as an external terminal as shown in FIGS. 18 and 19. The terminal 300 according to the present embodiment is a brass member subjected to copper plating and tin plating. According to the present embodiment, while a resin plate (inner resin plate, outer resin plate) 310 is interposed between the terminal 300 and the inner lead 132 or between the terminal 300 and the outer lead 142, the inner lead 132 or the outer lead 142 is electrically connected with the terminal 300 by an aluminum pin (inner aluminum pin, outer aluminum pin) 320 which pierces through the inner lead 132 or the outer lead 142, the terminal 300 and the resin plate (inner resin plate, outer resin plate) 310. More specially, in the present embodiment, the aluminum pin 320 is successively passed through the terminal 300, the resin plate 310, an aluminum ring 330, the inner lead 132 or the outer lead 142, and the aluminum ring 330. Then, a tip of the aluminum pin 320 is crushed while a pin head 322 of the aluminum pin 320 is pressed against the terminal 300 so that a pin-crushed portion 324 is formed to fix the aluminum pin 320. When the resin plate 310 is interposed therebetween, the resin plate 310 partly protect a conjunction part between the aluminum pin 320 and the terminal 300 made of a material different from the aluminum pin 320 so that corrosion of the conjunction part can be prevented. The resin plate 310 may have various shape and can be used as a terminal block. In addition, from the viewpoint of further prevention of corrosion, resin 340 may cover a conjunction part between the pin head 322 and the terminal 300 as shown in FIG. 20. Furthermore, from the viewpoint of more prevention of corrosion, as shown in FIG. 21, a part of the resin plate 310 on the pin-crushed portion 324 side, namely, the inner lead 132 or the outer lead 142, the aluminum ring 330 and the pin-crushed portion 324, may be covered with the resin 342. Furthermore, a resin such as an adhesive or the like, instead of the resin plate 310, may cover a conjunction part between the terminal 300 and the aluminum pin 320 or other parts made of aluminum.

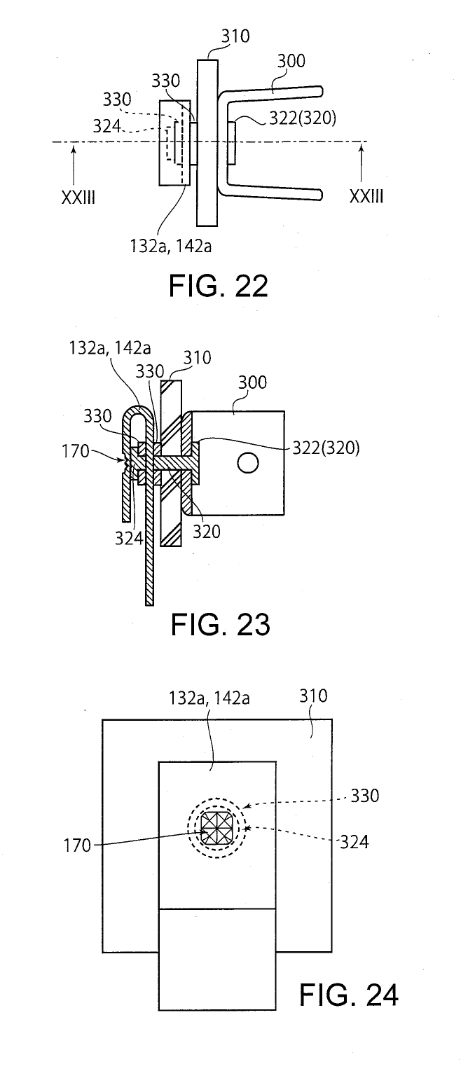

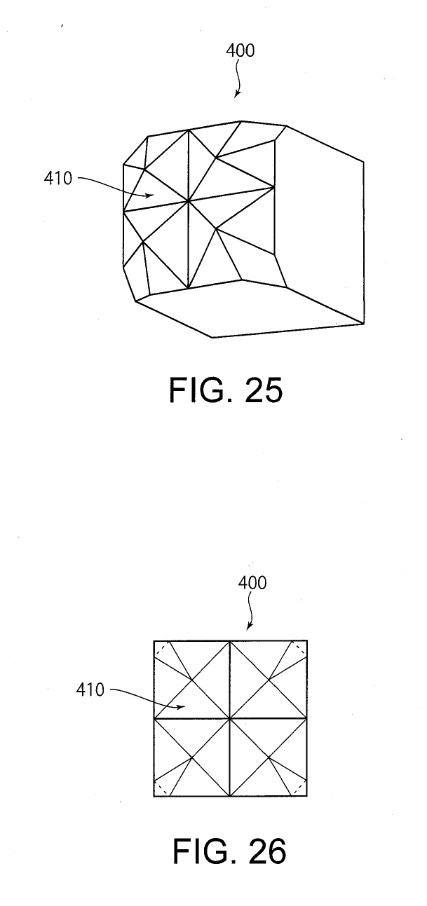

In addition, to secure a high contact reliability, an inner lead 132a and an outer lead 142a may be welded to the aluminum pin 320 through ultra-sonic welding as shown in FIGS. 22 to 24. In detail, the inner lead 132a and the outer lead 142a are longer than the aforementioned inner lead 132 and the aforementioned outer lead 142 (see FIGS. 18 and 19). The inner lead 132a and the outer lead 142a are doubled over to overlap on the pin-crushed portion 324 and are welded to the pin-crushed portion 324 through ultra-sonic welding by using a pressing portion 410 of a pressing member 400 as shown in FIGS. 25 and 26. A pressed mark 170 due to a shape of the pressing portion 410 is formed on each of the inner lead 132a and the outer lead 142a.

In detail, the pressing member 400, has the pressing portion 410 having a shape obtained by chamfering corner parts of an assembly consisting of four square pyramids, wherein the assembly has a quadrangle shape when seen along a pressing direction, as shown in FIGS. 25 and 26. The pressing portion 410 has an outer peripheral shape which neither include a corner part of a right angle nor an acute angle, wherein the outer peripheral shape is an octagonal shape containing four dotted lines in FIG. 26. The pressing portion 410 may be based on an assembly consisting of a plurality, other than four, of square pyramids and may be based on an assembly consisting of a plurality of cones or other arbitrary polygonal pyramids instead of square pyramids. However, considering a formation cost of the pressing member 400, it is preferable that the pressing member 400 is based on an assembly consisting of a plurality of square pyramids. In addition, the pressing portion 410 may have an outer peripheral shape obtained by rounding corner parts of quadrangle. In other words, an outer peripheral shape of the pressing portion includes a curve.

Referring to FIG. 24, the pressed mark 170 according to the present embodiment has a shape due to an outer peripheral shape (see FIGS. 25 and 26) of the pressing portion 410 of the pressing member 400. In detail, the pressed mark 170 has a depression due to square pyramids of the pressing portion 410 and an outer shape (i.e. an shape obtained by slightly rounding corners of octagonal shape) due to an outer peripheral shape (i.e. an octagonal shape in the present embodiment) of the pressing portion 410. When the pressing portion 410 has an outer peripheral shape which includes a corner part making an either right angle or an acute angle, such as simple quadrangle, there is a possibility that the inner lead 132a or the outer lead 142a is broken by a part of the corner part of the outer peripheral shape. However, when the pressing portion 410 has the outer peripheral shape which neither include a corner part of a right angle nor a corner part of an acute angle as in the present embodiment, a risk that the inner lead 132a and the outer lead 142a are broken by pressing with the pressing portion 410 can be reduced.

While the present invention has been described with specific embodiments, the present invention is not limited to the aforementioned embodiments.

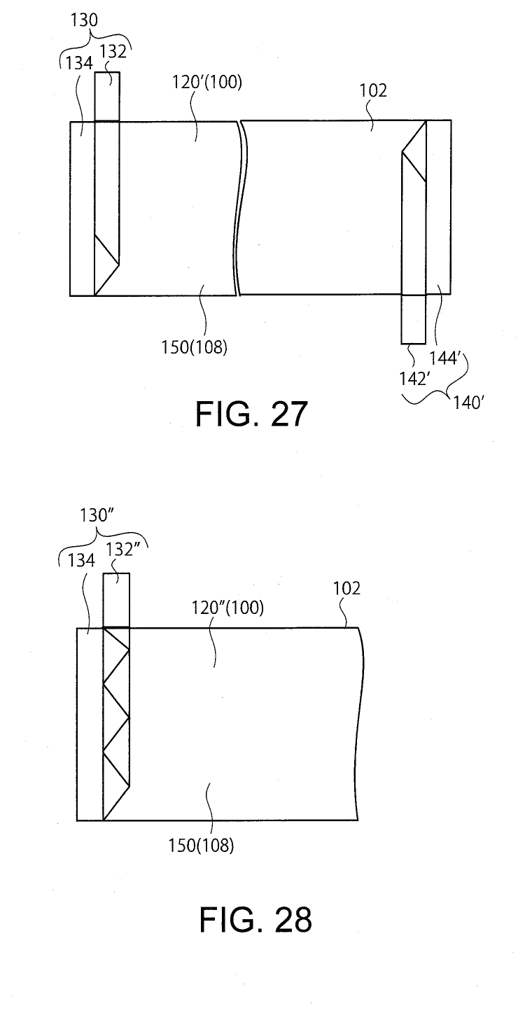

Specially, in the aforementioned embodiments, the inner lead 132 and the outer lead 142 project out beyond the coil main 150 in the same direction as each other, as shown in FIG. 3, the present invention is not limited thereto. For example, as shown in FIG. 27, a conductive member 120′ may be formed by modifying the inner end 130 and an outer end 140′ so that the inner lead 132 and an outer lead 142′ project out beyond the coil main 150 in opposite directions to each other.

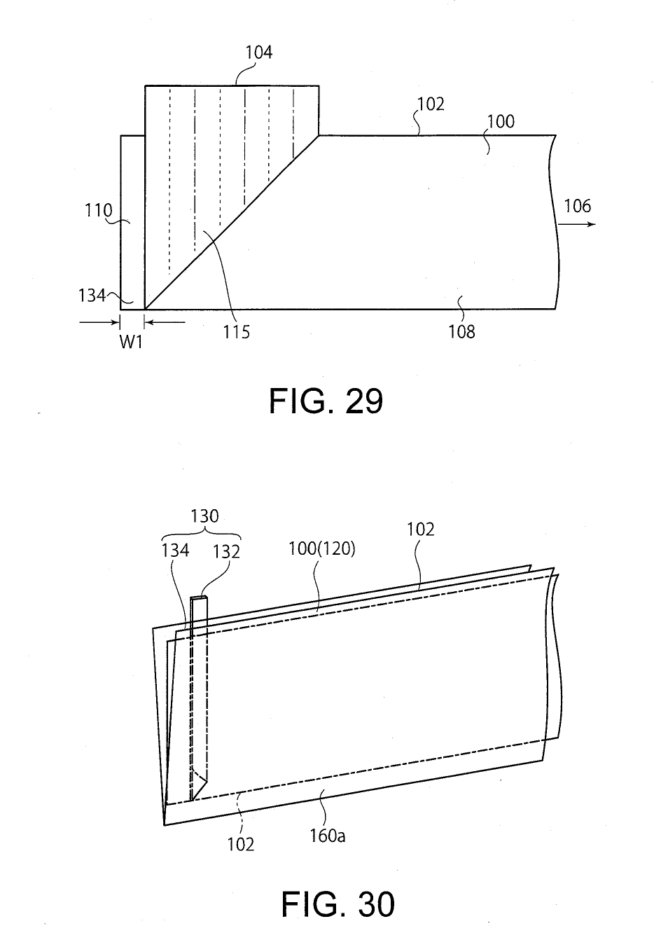

In addition, although the inner lead 132 is formed by rolling the folded portion 115 up by using the winding core 20 as shown in FIG. 7, followed by pressing the folded portion 115 in the aforementioned embodiments, the present invention is not limited thereto. For example, the inner lead 132 as shown in FIG. 9 may be formed by sequentially folding the folded portion 115 from the end thereof without using the winding core 20. As understood in FIGS. 28 and 27, a method of folding the folded portion 115 may be changed. In FIG. 29, dashed-dotted lines show valley fold while dotted lines show mountain fold. Referring to FIGS. 28 and 29, yet another conductive member 120″ comprises an inner end 130″ including an inner lead 132″ formed by folding up the folded portion 115 in a zigzag form.

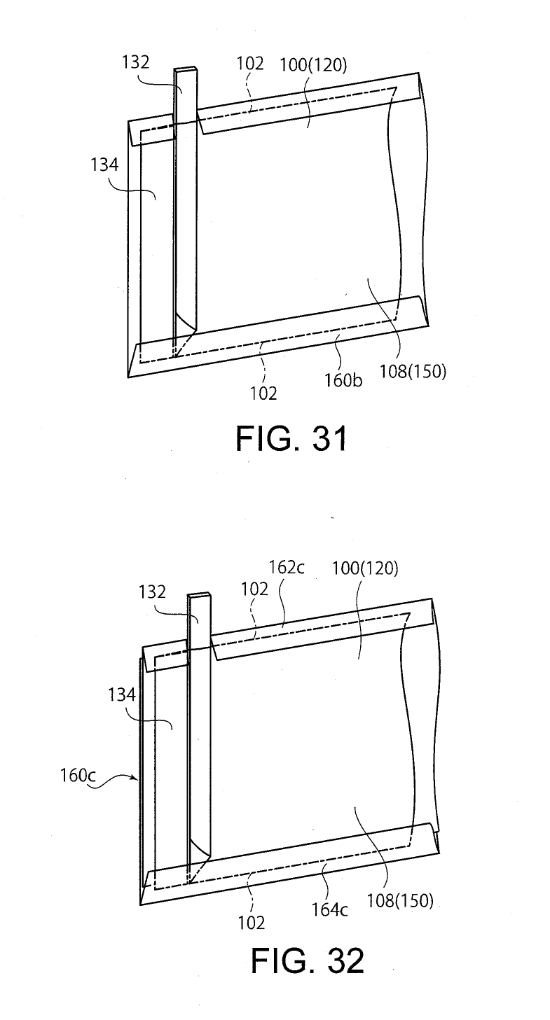

Furthermore, although the insulation separator 160 is not especially folded on the conductive member 120 in the aforementioned embodiments, the present invention is not limited thereto. For example, as shown in FIG. 30, an insulation separator 160a may be folded in two to sandwich the whole conductive member 120 therebetween. In addition, as shown in FIG. 31, opposite ends of an insulation separator 160b in the lateral direction may be folded to cover only the edge 102. Furthermore, as shown in FIG. 32, an insulation separator 160c may be formed by two insulation films 162c, 164c, and the two insulation films 162c, 164c may be folded to cover the two edges 102 with the insulation films 162c, 164c, respectively. In addition to the constitution shown in FIG. 32, the insulation film 162c may have excellent wettability for varnish resin while the insulation film 164c may have high tensile strength.

Various materials can be used as an insulation separator. For example, the insulation separator may be integrated with a film conductor, An insulation separator may have an adhesive layer and may be adhered to a film conductor by the adhesive layer. The insulation separator may be a paper such as a common kraft paper or manila paper and may be a resin sheet such as PET, PEN, PPS or the like. Furthermore, the insulation separator may be fiber nonwoven fabric composed of glass or heat resistant fiber.

Although In the aforementioned embodiments, the bobbin 30 consists of the two split bobbins 32, 34 and is hollow as shown in FIGS. 13 and 14, the present invention is not limited thereto. For example, a single bobbin formed with a ditch or a slit for holding the inner margin or the like may be used. A bobbin consisting of two split bobbins, which is not hollow under a state where the two split bobbins are combined, may be used. Furthermore, a bobbin consisting of three or more split bobbins may be used. In addition, to facilitate removal of a bobbin after winding the coil 1, the bobbin may be coated with fluorocarbon resin to slide smoothly.

Furthermore, after a formation of a reactor by using the thus-obtained coil 1, the whole reactor or the whole coil 1 may be coated with curable resin such as curable varnish or thermoplastic resin. Furthermore, the reactor may be accommodated in a resin-molded cap and case and, then, be covered with resin.

In the aforementioned embodiments, the inner lead 132 is formed by forming the inner margin 134 as well as the folded portion 115, followed by folding the folded portion 115, as described by using FIGS. 4 to 9. The formation order of each portion may be varied. For example, the inner lead 132 may be formed by forming the folded portion 115 without leaving the predetermined size W1, followed by forming the inner margin 134 having the predetermined size W1, further followed by folding the folded portion 115. In addition, after the inner lead 132 is formed by folding the folded portion 115 without leaving the predetermined size W1, the inner margin 134 having the predetermined size W1 may be formed.

In the present invention, the inner margin 134 is an essential portion, but the outer margin 144 may be omitted. However, as previously described, a formation of the coil 1 can be surely maintained by forming the outer margin 144. Therefore, it is preferable that the outer end 140 has the outer margin 155.

### INDUSTRIAL APPLICABILITY

The reactor comprising the coil according to the present invention is usable in power convertor and inverter in general.

The present application is based on a Japanese patent application of JP2011-267929 filed before the Japan Patent Office on Dec. 7, 2011, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

### REFERENCE SIGNS LIST

1 Coil
5 Magnetic Core
10 Reactor
20 Winding Core
30 Bobbin
32 Split Bobbin
34 Split Bobbin
100 Film Conductor
102 Edge
104 One End
106 Other End
108 Main Section
W1 Predetermined Size
W2 Size
110 Double-over Portion
115 Folded Portion
120 Conductive Member
130 Inner End
132 Inner Lead
134 Inner Margin
140 Outer End
142 Outer Lead
144 Outer Margin
150 Coil Main
160, 160a, 160b, 160c Insulation Separator
162c Insulation Film
164c Insulation Film
170 Pressed Mark
D Difference
310 Terminal
310 Resin Plate
320 Aluminum Pin
322 Pin Head
324 Pin-Crushed Portion
330 Aluminum Ring
340 Resin
342 Resin
400 Pressing Member
410 Pressing Portion

1. A coil formed by winding a conductive member and an insulation separator together, wherein:
the conductive member is formed by folding a film conductor and includes two ends of an inner end and an outer end and a coil main positioned between the inner end and the outer end;
the inner end is positioned on a center of the coil while the outer end is positioned at the outermost portion of the coil;
the inner end includes an inner lead and an inner margin, the inner margin being positioned between the inner lead and the coil main, the inner margin being doubled over to have a predetermined size in a circumference direction, the inner margin forming the innermost portion of the conductive member in the circumference direction;
the outer end includes an outer lead; and
the inner lead and the outer lead project out beyond the coil main in a winding-axis direction intersecting the circumference direction.

2. The coil as recited in claim 1, wherein the inner margin do not project out beyond the coil main in the winding-axis direction.

3. The coil as recited in claim 1, wherein the inner end has a structure obtained by folding an one end of the film conductor toward the other end in the longitudinal direction; followed by folding the one end with a double-over portion of the predetermined size left and with the one end projecting out beyond an edge of the film conductor in a lateral direction perpendicular to the longitudinal direction, so that the inner margin and a folded portion are formed; further followed by folding the folded portion to form the inner lead.

4. The coil as recited in claim 3, wherein the predetermined size is 0.1 to 15 times a size of the inner lead in the circumference direction.

5. The coil as recited in claim 4, wherein the predetermined size is 0.5 to 5 times the size of the inner lead in the circumference direction.

6. The coil as recited in claim 1, wherein the outer end further includes an outer margin, the outer margin being located between the outer lead and the coil main, the outer margin being doubled over to form an outermost portion of the conductive member in the circumference direction.

7. A reactor comprising the coil as recited in claim 1.

8. The reactor as recited in claim 7, wherein:
the reactor further comprises an inner terminal, an outer terminal, an inner resin plate and an outer resin plate, the inner terminal and the outer terminal being connected with the inner lead and the outer lead, respectively;
the film conductor is made of aluminum foil;
the inner terminal and the outer terminal are made of conductors other than aluminum;
while the inner resin plate is interposed between the inner lead and the inner terminal, the inner lead is electrically connected with the inner terminal by using an inner aluminum pin which pierces the inner lead, the inner terminal and the inner resin plate; and
while the outer resin plate is interposed between the outer lead and the outer terminal, the outer lead is electrically connected with the outer terminal by using an outer aluminum pin which pierces the outer lead, the outer terminal and the outer resin plate.

9. The reactor as recited in claim 8, wherein:
the inner lead and the outer lead are welded to the inner aluminum pin and the outer aluminum pin, respectively, through ultra-sonic welding by using a pressing member including a pressing portion, the pressing portion having a shape based on an assembly consisting of a plurality of cones or pyramids, the pressing portion having an outer peripheral shape which neither include a corner part of a right angle nor a corner part of an acute angle; and
the inner lead and the outer lead are provided with pressed marks, respectively, the pressed mark having a depression due to the cones or pyramids of the pressing portion, the pressed mark having an outer shape due to the outer peripheral shape of the pressing portion.

10. The reactor as recited in claim 9, wherein:
the pressing portion has an outer peripheral shape obtained by chamfering or rounding corner parts of a quadrangle; and
the pressing mark is provided by the pressing member having the pressing portion.

11. A coil formation method comprising:
a forming step in which an inner lead and an inner margin are formed by folding an one end of a film conductor and its vicinity in a longitudinal direction, the inner lead projecting out beyond an edge of the film conductor in the lateral direction of the film conductor, the inner margin being positioned between a main section of the film conductor and the inner lead, the inner margin being a centralmost portion in the coil by being doubled over to have a predetermined size in the longitudinal direction, the main section becoming the coil main by being wound in a later step; and
a winding step in which the film conductor and an insulation separator are wound together in a state where the inner margin is held by a bobbin.

12. The coil formation method as recited in claim 11, wherein the forming step comprises:
an inner margin formation step, in which the inner margin of predetermined size and a folded portion are formed by folding the one end of the film conductor toward the other end of the film conductor in the longitudinal direction, followed by folding the one end with a double-over portion of the predetermined size left and with the one end projecting out beyond the edge of the film conductor in a lateral direction; and
an inner lead formation step, in which the inner lead is formed by folding the folded portion, the inner lead projecting out beyond the edge of the film conductor in the lateral direction.

13. The coil formation method as recited in claim 11, wherein while the bobbin holds the end of the insulation separator and the inner margin together, the winding is performed in the winding step.

14. The coil formation method as recited in claim 13, wherein, while a part of the main section of the film conductor is interposed between the bobbin and the inner lead, the winding is performed in the winding step.

15. The coil formation method as recited in claim 11, further comprising:
an outer margin formation step, in which an outer margin as an outermost end of the coil and an outer folded portion are formed by folding the other end of the film conductor toward the one end, followed by folding the other end with a double-over portion left partly and with the other end projecting out beyond the edge of the film conductor in the lateral direction; and
an outer lead formation step, in which an outer lead is formed by folding the outer folded portion, the outer lead projecting out beyond the edge of the film conductor in the lateral direction.

16. The coil formation method as recited in claim 11, comprising a bobbin removal step in which the bobbin is removed after the winding, so that an air-core coil is formed as the coil.
